(19) United States
(12) Patent Application Publication
(10) Pub. No.: US 2023/0222803 A1
(43) Pub. Date: Jul. 13, 2023

(54) PROCESSING APPARATUS, PROCESSING METHOD, AND NON-TRANSITORY STORAGE MEDIUM

(71) Applicant: NEC Corporation, Minato-ku, Tokyo (JP)

(72) Inventors: Yu NABETO, Tokyo (JP); Katsumi Kikuchi, Tokyo (JP); Takami Sato, Tokyo (JP); Soma Shiraishi, Tokyo (JP)

(73) Assignee: NEC Corporation, Minato-ku, Tokyo (JP)

(21) Appl. No.: 18/007,756

(22) PCT Filed: Jun. 3, 2020
(86) PCT No.: PCT/JP2020/021911

§ 371 Date: Dec. 2, 2022

(51) Int. Cl. G06V 20/52; G06V 10/764; G06V 10/44

(52) U.S. Cl. CPC G06V 20/52; G06V 10/764; G06V 10/44

(57) ABSTRACT

The present invention provides a processing apparatus (10) including: an acquisition unit (11) that acquires a product pickup image indicating a scene of picking up a product from a first product shelf by a customer; a determination unit (12) that determines a product group displayed on the first product shelf, based on shelf-based display information indicating a product displayed on each product shelf; and a first recognition unit (13) that recognizes a product included in the product pickup image by recognition processing in which the determined product group is set as a collation target among pieces of product feature value information indicating a feature value of an external appearance of a plurality of products.

### TECHNICAL FIELD

The present invention relates to a processing apparatus, a processing method, and a program.

### BACKGROUND ART

Non-Patent Documents 1 and 2 disclose a store system in which settlement processing (such as product registration and payment) at a cash register counter is eliminated. In the technique, a product picked up by a customer is recognized based on an image generated by a camera for photographing inside a store, and settlement processing is automatically performed based on a recognition result at a timing when the customer goes out of the store.

Patent Document 1 discloses a technique of determining the number of products picked up from a product shelf by a customer, based on a photographed image of a surveillance camera, and detecting illegality by collating between the number of products registered in a POS terminal at a time of settlement, and the number of picked up products determined in advance.

### RELATED DOCUMENT

### Patent Document

[Patent Document 1] Japanese Patent Application Publication No. 2004-171241

### Non-Patent Document

[Non-Patent Document 1] Takuya MIYATA, “Mechanism of Amazon Go, Supermarket without Cash Register Achieved by ‘Camera and Microphone’”, [online], Dec. 10, 2016, [searched on Dec. 6, 2019], the Internet <URL:https//www.huffingtonpost.jp/tak-miyata/amazon-go_b_13521384.html>
[Non-Patent Document 2] “NEC, Cash Register-less Store ‘NEC SMART STORE’ is Open in Head Office—Face Recognition Use, Settlement Simultaneously with Exit of Store”, [online]. Feb. 28, 2020, [searched on Mar. 27, 2020], the Internet <URL:https://japan.cnet.com/article/35150024/>

### DISCLOSURE OF THE INVENTION

### Technical Problem

In a technique of recognizing a product by collating between information (such as a feature value of an external appearance) on each of a plurality of products registered in advance, and information (such as a feature value of an external appearance) on an object indicated by an image, there is a problem that, as the number of products handled in a store increases, and the number of products as a collation target increases, a processing load of a computer increases. Non-Patent Documents 1 and 2, and Patent Document 1 do not disclose the problem.

An object of the present invention is to reduce a processing load of a computer in a technique of recognizing a product by collating between information on each of a plurality of products registered in advance, and information on an object indicated by an image.

### Solution to Problem

The present invention provides a processing apparatus including:

an acquisition unit that acquires a product pickup image indicating a scene of picking up a product from a first product shelf by a customer;

a determination unit that determines a product group displayed on the first product shelf, based on shelf-based display information indicating a product displayed on each product shelf; and

a first recognition unit that recognizes a product included in the product pickup image by recognition processing in which the determined product group is set as a collation target among pieces of product feature value information indicating a feature value of an external appearance of a plurality of products.

Further, the present invention provides a processing method including,

by a computer:

acquiring a product pickup image indicating a scene of picking up a product from a first product shelf by a customer;

determining a product group displayed on the first product shelf, based on shelf-based display information indicating a product displayed on each product shelf; and

recognizing a product included in the product pickup image by recognition processing in which the determined product group is set as a collation target among pieces of product feature value information indicating a feature value of an external appearance of a plurality of products.

Further, the present invention provides a program causing a computer to function as:

an acquisition unit that acquires a product pickup image indicating a scene of picking up a product from a first product shelf by a customer;

a determination unit that determines a product group displayed on the first product shelf, based on shelf-based display information indicating a product displayed on each product shelf; and

a first recognition unit that recognizes a product included in the product pickup image by recognition processing in which the determined product group is set as a collation target among pieces of product feature value information indicating a feature value of an external appearance of a plurality of products.

### Advantageous Effects of Invention

The present invention reduces a processing load of a computer in a technique of recognizing a product by collating between information on each of a plurality of products registered in advance, and information on an object indicated by an image.

### FRIED DESCRIPTION OF THE DRAWINGS

FIG. 1 is a diagram illustrating one example of a hardware configuration of a processing apparatus according to the present example embodiment.

FIG. 2 is one example of a functional block diagram of the processing apparatus according to the present example embodiment.

FIG. 3 is a diagram illustrating an installation example of a camera according to the present example embodiment.

FIG. 4 is a diagram illustrating an installation example of the camera according to the present example embodiment.

FIG. 5 is a diagram illustrating one example of an image to be generated by a camera according to the present example embodiment.

FIG. 6 is a diagram illustrating a relationship among the processing apparatus according to the present example embodiment, a camera, and a product shelf.

FIG. 7 is a diagram illustrating one example of information to be processed by the processing apparatus according to the present example embodiment.

FIG. 8 is a diagram illustrating one example of information to be processed by the processing apparatus according to the present example embodiment.

FIG. 9 is a flowchart illustrating one example of a flow of processing of the processing apparatus according to the present example embodiment.

FIG. 10 is a flowchart illustrating one example of a flow of processing of the processing apparatus according to the present example embodiment.

FIG. 11 is a diagram illustrating one example of information to be processed by the processing apparatus according to the present example embodiment.

FIG. 12 is one example of a functional block diagram of the processing apparatus according to the present example embodiment.

FIG. 13 is a flowchart illustrating one example of a flow of processing of the processing apparatus according to the present example embodiment.

FIG. 14 is one example of a functional block diagram of the processing apparatus according to the present example embodiment.

FIG. 15 is a flowchart illustrating one example of a flow of processing of the processing apparatus according to the present example embodiment.

FIG. 16 is a flowchart illustrating one example of a flow of processing of the processing apparatus according to the present example embodiment.

FIG. 17 is a flowchart illustrating one example of a flow of processing of the processing apparatus according to the present example embodiment.

### DESCRIPTION OF EMBODIMENTS

### First Example Embodiment

### “Overview”

A processing apparatus according to a present example embodiment determines, in response to acquisition of a product pickup image indicating a scene of picking up a product from a product shelf by a customer, a product group displayed on the product shelf from which the customer picks up the product, based on shelf-based display information generated in advance. Further, the processing apparatus recognizes the product included in the product pickup image by recognition processing in which a feature value of an external appearance of the determined product group is set as a collation target among pieces of product feature value information indicating a feature value of an external appearance of a plurality of products.

According to the processing apparatus as described above, since only a part of pieces of product feature value information indicating a feature value of an external appearance of a plurality of products can be set as a collation target, a processing load of the processing apparatus is reduced.

### “Hardware Configuration”

Next, one example of a hardware configuration of the processing apparatus is described.

Each functional unit of the processing apparatus is achieved by any combination of hardware and software mainly including a central processing unit (CPU) of any computer, a memory, a program loaded in a memory, a storage unit (capable of storing, in addition to a program stored in advance at a shipping stage of an apparatus, a program downloaded from a storage medium such as a compact disc (CD), a server on the Internet, and the like) such as a hard disk storing the program, and an interface for network connection. Further, it is understood by a person skilled in the art that there are various modification examples as a method and an apparatus for achieving the configuration.

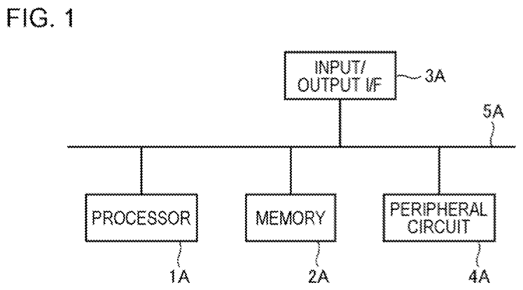

FIG. 1 is a block diagram illustrating a hardware configuration of the processing apparatus. As illustrated in FIG. 1, the processing apparatus includes a processor 1A, a memory 2A, an input/output interface 3A, a peripheral circuit 4A, and a bus 5A. The peripheral circuit 4A includes various modules. The processing apparatus may not include the peripheral circuit 4A. Note that, the processing apparatus may be constituted of a plurality of apparatuses that are physically and/or logically separated, or may be constituted of one apparatus that is physically and/or logically integrated. In a case where the processing apparatus is constituted of a plurality of apparatuses that are physically and/or logically separated, each of the plurality of apparatuses can include the above-described hardware configuration.

The bus 5A is a data transmission path along which the processor 1A, the memory 2A, the peripheral circuit 4A, and the input/output interface 3A mutually transmit and receive data. The processor 1A is, for example, an arithmetic processing apparatus such as a CPU and a graphics processing unit (GPU). The memory 2A is, for example, a memory such as a random access memory (RAM) and a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, and the like. The processor 1A can issue a command to each module, and perform arithmetic operation, based on these arithmetic operation results.

### “Functional Configuration”

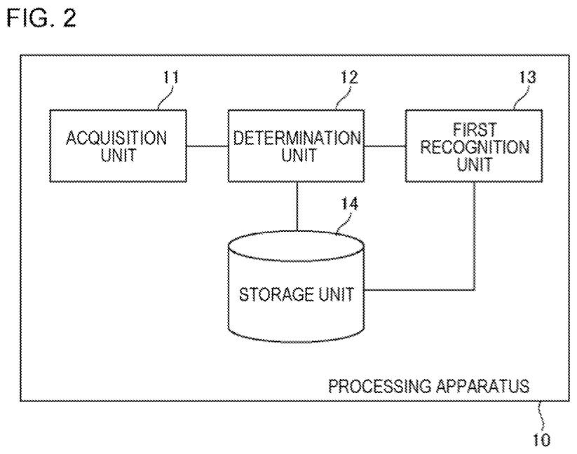

FIG. 2 illustrates one example of a functional block diagram of a processing apparatus 10. As illustrated in FIG. 2, the processing apparatus 10 includes an acquisition unit 11, a determination unit 12, a first recognition unit 13, and a storage unit 14.

The acquisition unit 11 acquires a product pickup image indicating a scene of picking up a product from a product shelf by a customer.

Herein, a camera for generating a product pickup image is described. The camera is installed at a position and in an orientation in which a scene of picking up a product from a product shelf by a customer is photographed. The camera may be installed on a product shelf, may be installed on a ceiling, may be installed on a floor, may be installed on a wall surface, or may be installed at another location.

Further, the number of cameras for photographing a scene of picking up a product from one product shelf by a customer may be one or plural. In a case where a scene of picking up a product from one product shelf by a customer is photographed by a plurality of cameras, it is preferable that the plurality of cameras are installed in such a way as to photograph the scene of picking up the product from the product shelf by the customer at positions and in orientations different from each other.

Further, a camera may be installed for each product shelf, a camera may be installed at every other plurality of product shelves, a camera may be installed at each stage of a product shelf, or a camera may be installed at every other plurality of stages of a product shelf.

A camera may photograph a moving image constantly (e.g., during business hours), may continuously photograph a still image at a time interval larger than a frame interval of a moving image, or these photographing operations may be performed only during a time when a person present at a predetermined position (such as in front of a product shelf) is detected by a human sensor or the like.

A product pickup image generated by a camera may be input to the processing apparatus 10 by real-time processing, or may be input to the processing apparatus 10 by batch processing. Which processing is used can be determined, for example, according to a usage content of a product recognition result.

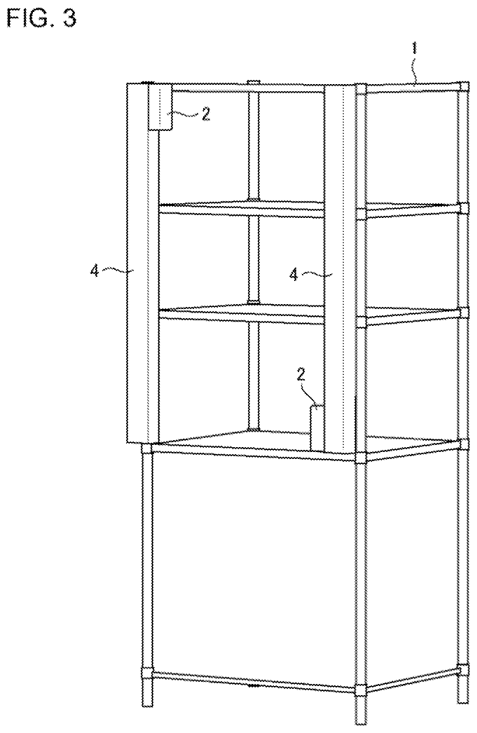

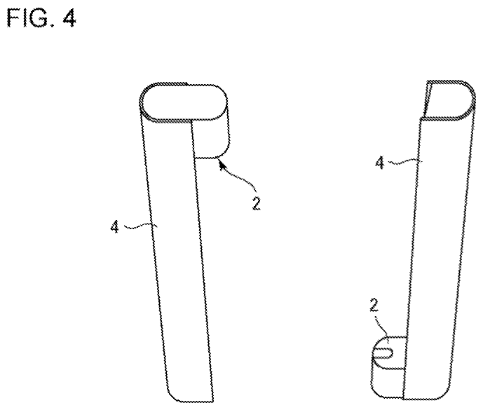

Herein, one example of camera installation is described. Note that, a camera installation example described herein is merely one example, and the present example embodiment is not limited thereto. In the example illustrated in FIG. 3, two cameras 2 are installed for each product shelf 1. FIG. 4 is a diagram in which a frame 4 in FIG. 3 is extracted. A camera 2 and an illumination (not illustrated) are provided for each of two components constituting the frame 4.

A light irradiation surface of the illumination extends in one direction, and the illumination includes a light emitting unit, and a cover for covering the light emitting unit. The illumination mainly irradiates light in a direction orthogonal to an extending direction of the light irradiation surface. The light emitting unit includes a light emitting element such as a LED, and irradiates light in a direction in which the illumination is not covered by the cover. Note that, in a case where the light emitting element is a LED, a plurality of LEDs are aligned in a direction (up-down direction in the figure) in which the illumination extends.

Further, the camera 2 is provided at one end side of a component of the linearly extending frame 4, and has a photographing region in a direction in which light of the illumination is irradiated. For example, in a component of the left-side frame 4 in FIG. 4, the camera 2 has a photographing region in a region extending downward and a region extending obliquely right downward. Further, in a component of the right-side frame 4 in FIG. 4, the camera 2 has a photographing region in a region extending upward and a region extending obliquely left upward.

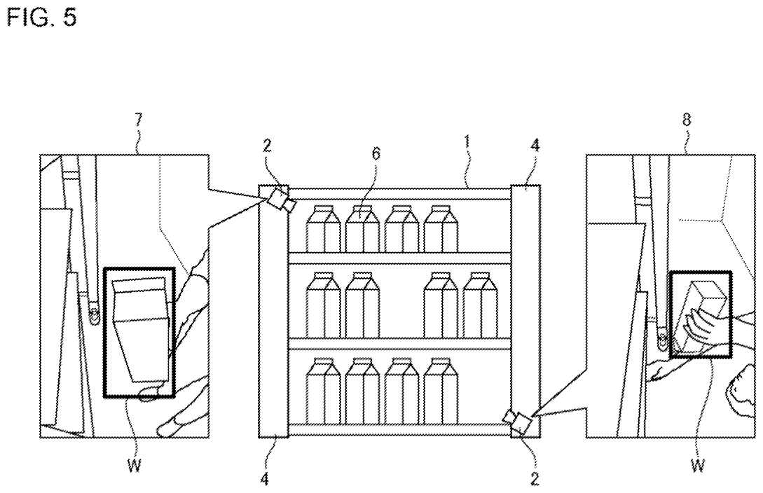

As illustrated in FIG. 3, the frame 4 is mounted on a front surface frame (or a front surface of a side wall on both sides) of the product shelf 1 constituting a product placement space. One of components of the frame 4 is mounted on one of the front surface frames in an orientation in which the camera 2 is located at a lower position, and the other of the components of the frame 4 is mounted on the other of the front surface frames in an orientation in which the camera 2 is located at an upper position. Further, the camera 2 mounted on one of the components of the frame 4 photographs an upper region and an obliquely upper region in such a way that an opening portion of the product shelf 1 is included in a photographing region. On the other hand, the camera 2 mounted on the other of the components of the frame 4 photographs a lower region and an obliquely lower region in such a way that the opening portion of the product shelf 1 is included in a photographing region. This configuration allows the two cameras 2 to photograph an entire region of the opening portion of the product shelf 1. In a case where a configuration illustrated in FIGS. 3 and 4 is adopted, as illustrated in FIG. 5, it becomes possible to photograph, by the two cameras 2, a scene of picking up a product from the product shelf 1 by a customer. Images 7 and 8 generated by the camera 2 as described above include a product picked up from the product shelf 1 by a customer.

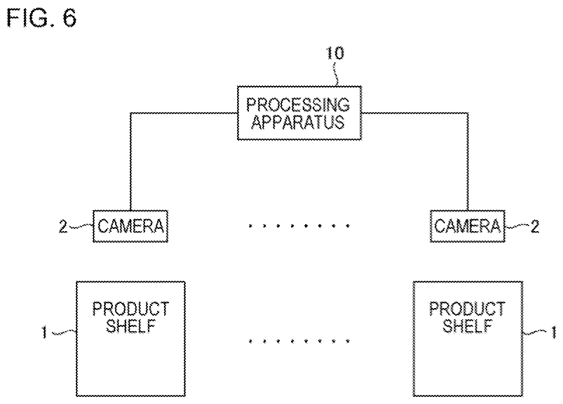

As illustrated in FIG. 6, in the present example embodiment, a plurality of cameras 2 are installed to photograph a scene of picking up a product from each of a plurality of product shelves 1 by a customer. Further, the acquisition unit 11 acquires a plurality of product pickup images generated by the plurality of cameras 2. Note that, in an example illustrated in FIG. 6, one camera 2 is installed in association with one product shelf 1, however, as described above, this configuration is merely one example, and the present example embodiment is not limited to this configuration.

Referring back to FIG. 2, first, the determination unit 12 determines from which one of a plurality of product shelves a product is picked up regarding a first product pickup image being one of a plurality of product pickup images acquired by the acquisition unit 11, which represents an image indicating a scene of picking up a product.

For example, in a case where installation positions of a plurality of cameras for photographing a plurality of product shelves are fixed, the determination unit 12 may determine from which product shelf, a product is picked up regarding the first product pickup image, which represents an image indicating a scene of picking up a product, by determining a camera that has generated the first product pickup image. In addition to the above, in a case where information indicating a photographing position is attached to a product pickup image, the determination unit 12 may determine from which product shelf, a product is picked up regarding the first product pickup image, which represents an image indicating a scene of picking up a product, by collating between information indicating the photographing position, and information indicating an installation position of each of a plurality of product shelves prepared in advance. In addition to the above, in a case where information (such as a shelf number) for mutual identification is physically attached to each of product shelves, and a product pickup image includes the information, the determination unit 12 may determine from which product shelf, a product is picked up regarding the first product pickup image, which represents an image indicating a scene of picking up a product, by analyzing the product pickup image, and recognizing the information attached to the product shelf.

Note that, hereinafter, it is assumed that “the first product pickup image” is an image indicating a scene of picking up a product from a “first product shelf” among a plurality of product shelves.

After determining that the first product pickup image is an image indicating a scene of picking up a product from the first product shelf, the determination unit 12 determines a product group displayed on the first product shelf, based on shelf-based display information. The shelf-based display information indicates a product displayed on each of a plurality of product shelves.

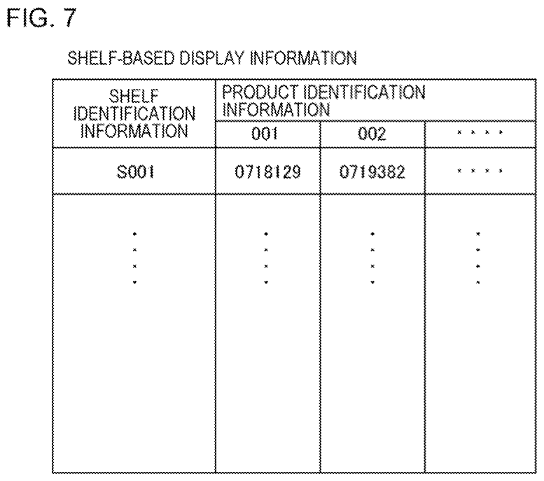

FIG. 7 illustrates one example of shelf-based display information. The illustrated shelf-based display information is information in which shelf identification information for mutually identifying a plurality of product shelves, and product identification information of a product displayed on each product shelf are associated with each other. For example, the storage unit 14 stores shelf-based display information.

The shelf-based display information may be information generated by an input work of an operator, or may be information automatically generated by an image analysis or the like. The latter example of automatic generation is described in detail in the following example embodiment.

Referring back to FIG. 2, the first recognition unit 13 recognizes a product included in the first product pickup image by recognition processing in which a part of pieces of product feature value information indicating a feature value of an external appearance of a plurality of products is set as a collation target. In the recognition processing, a feature value of another product not being included in the part does not become a collation target. The part as a collation target is a feature value of a product group determined, by the determination unit 12, as a product displayed on the first product shelf.

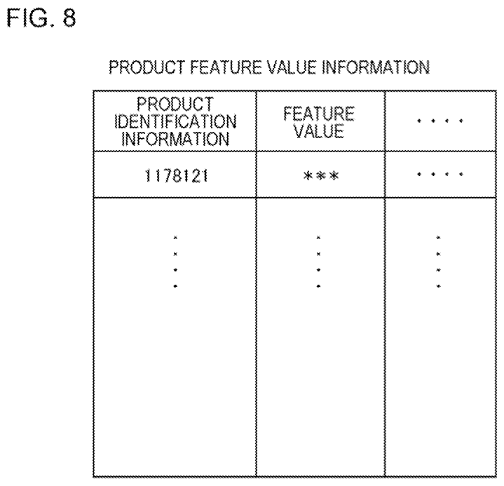

FIG. 8 schematically illustrates one example of product feature value information indicating a feature value of an external appearance of a plurality of products. The product feature value information indicates, for example, a feature value of an external appearance of a plurality of products handled in the store. For example, the storage unit 14 stores the product feature value information.

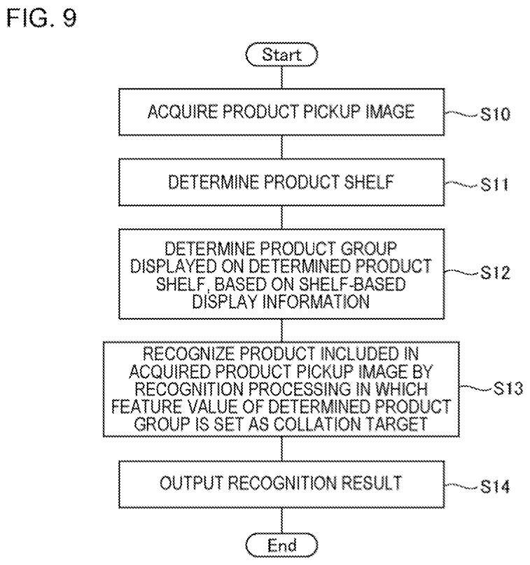

Next, one example of a flow of processing of the processing apparatus 10 is described by using a flowchart in FIG. 9.

First, in response to acquisition of a product pickup image as a processing target by the acquisition unit 11 (S10), the determination unit 12 determines from which one of a plurality of product shelves, a product is picked up regarding the product pickup image, which represents an image indicating a scene of picking up a product (S11). Subsequently, the determination unit 12 determines a product group displayed on the product shelf determined in S11, based on shelf-based display information (see FIG. 7) indicating a product displayed on each of the plurality of product shelves (S12).

Subsequently, the first recognition unit 13 recognizes a product included in the product pickup image acquired in S10 by recognition processing in which a feature value of an external appearance of the product group determined in S12 is set as a collation target among pieces of product feature value information (see FIG. 8) indicating a feature value of an external appearance of a plurality of products (S13). Then, the processing apparatus 10 outputs a recognition result (S14).

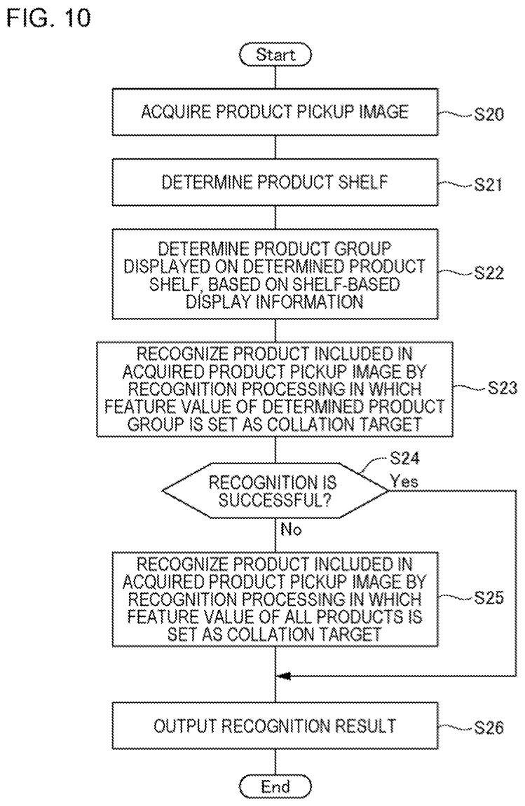

Next, another example of a flow of processing of the processing apparatus 10 is described by using a flowchart in FIG. 10.

First, in response to acquisition of a product pickup image as a processing target by the acquisition unit 11 (S20), the determination unit 12 determines from which one of a plurality of product shelves, a product is picked up regarding the product pickup image, which represents an image indicating a scene of picking up a product (S21). Subsequently, the determination unit 12 determines a product group displayed on the product shelf determined in S21, based on shelf-based display information (see FIG. 7) indicating a product displayed on each of the plurality of product shelves (S22).

Subsequently, the first recognition unit 13 recognizes a product included in the product pickup image acquired in S20 by recognition processing in which a feature value of an external appearance of the product group determined in S22 is set as a collation target among pieces of product feature value information (see FIG. 8) indicating a feature value of an external appearance of a plurality of products (S23). Then, in a case where the recognition processing in S22 is successful (Yes in S24), the processing apparatus 10 outputs a recognition result (S26).

“Recognition processing is successful” means that a recognition result in which reliability is equal to or more than a reference value is acquired. The reliability is computed, for example, based on the number of matched feature values, a ratio of the number of matched feature values with respect to the number of feature values registered in advance, and the like.

For example, in a case where a customer returns a product pickup from a product shelf to a product shelf different from the original product shelf, and the like, a situation in which the product is not displayed on the product shelf on which the product is supposed to be present may occur. Specifically, a situation in which a product different from a product to be displayed on a certain product shelf indicated by shelf-based display information is displayed on the product shelf may occur. In this case, a situation (recognition processing has failed) in which a product cannot be accurately recognized by recognition processing in which only a feature value of a product group determined based on shelf-based display information is set as a collation target may occur.

In the processing example, in a case where recognition processing in S22 has failed (No in S24), the first recognition unit 13 recognizes a product included in the product pickup image acquired in S20 by recognition processing in which a feature value of an external appearance of all products indicated by product feature value information (see FIG. 8) is set as a collation target (S25). Then, the processing apparatus 10 outputs a recognition result (S26).

Note that, in the present example embodiment, a processing content thereafter with respect to a result (product recognition result) of recognition processing by the first recognition unit 13 is not specifically limited.

For example, a product recognition result may be utilized by settlement processing in a store system in which settlement processing (such as product registration and payment) at a cash register counter is eliminated, as disclosed in Non-Patent Documents 1 and 2. In the following, one example is described.

First, a store system registers an output product recognition result (product identification information) in association with information for determining a customer holding a product in a hand. For example, a camera for photographing a face of a customer holding a product in a hand may be installed in a store, and a store system may extract, from an image generated by the camera, a feature value of an external appearance of the face of the customer. Further, the store system may register product identification information of the product held in the hand of the customer, and other product information (such as a unit price, and a product name) in association with a feature value (information for determining a customer) of an external appearance of the face. The other product information can be acquired from a product master (information in which product identification information, and other product information are associated with each other), which is stored in the store system in advance.

In addition to the above, customer identification information (such as a membership number and a name) of a customer, and a feature value of an external appearance of a face may be registered in advance in association with each other at any location (such as a store system, and a center server). Further, when extracting, from an image including a face of a customer holding a product in a hand, a feature value of an external appearance of the face of the customer, the store system may determine customer identification information of the customer, based on the information registered in advance. Further, the store system may register product identification information of a product held in a hand of the customer and other product information in association with the determined customer identification information.

Further, the store system computes a settlement amount, based on a registration content, and performs settlement processing. For example, settlement processing is performed at a timing when a customer leaves a store through a gate, a timing when a customer goes out of a store through an exit, or the like. Detection of these timings may be achieved by detecting that a customer leaves a store by an image generated by a camera installed at a gate or an exit, may be achieved by inputting, to an input apparatus (such as a reader for performing near field communication) installed at a gate or an exit, customer identification information of a customer who leaves a store, or may be achieved by another method. Details on settlement processing may be settlement processing by a credit card based on credit card information registered in advance, may be settlement based on pre-charged money, or may be other than the above.

As another usage scene on a recognition processing result (product recognition result) by the first recognition unit 13, a preference survey of a customer, a marketing research, and the like are exemplified. For example, it is possible to analyze a product and the like in which each customer is interested by registering a product picked up by each customer in association with each customer. Further, it is possible to analyze in which product, a customer is interested by registering that the customer has picked up a product for each product. Furthermore, it is possible to analyze an attribute of a customer who is interested in each product by estimating an attribute (such as gender, an age group, and nationality) of a customer by utilizing a conventional image analysis technique, and registering an attribute of a customer who has picked up each product.

### Advantageous Effect

In the above-described processing apparatus 10 according to the present example embodiment, it is possible to recognize a product included in an image by recognition processing in which only a feature value of an external appearance of “a product group displayed on a product shelf from which a product is picked up” among pieces of product feature value information indicating a feature value of an external appearance of a plurality of products is set as a collation target, without setting, as a collation target, a feature value of an external appearance of “all products”. According to the processing apparatus 10 as described above, since the number of collation targets can be reduced, a processing load of the processing apparatus 10 is reduced.

Further, the processing apparatus 10 determines from which product shelf, a product is picked up regarding an image as a processing target, which represents an image indicating a scene of picking up a product, and sets, as a collation target, a feature value of a product group displayed on the determined product shelf. According to the processing apparatus 10 as described above, since a collation target can be appropriately narrowed down, it is possible to suppress occurrence of an inconvenience that matching information is not included in a collation target.

Further, as illustrated in a flowchart in FIG. 10, for example, the processing apparatus 10 has a two-step configuration constituted of first recognition processing in which a feature value of a part of products is set as a collation target, and second recognition processing in which feature values of all products are set as a collation target, and in a case where product recognition cannot be accurately performed by the first recognition processing, the second recognition processing can be performed. In this case, for example, even in a case where a situation in which a product is not displayed on a product shelf on which the product is supposed to be present occurs resulting from that a customer has returned the product picked up from a product shelf to a product shelf different from the original product shelf, and the like, it is possible to accurately recognize the product picked up from the product shelf by the customer. Further, providing the two-step configuration enables to suppress an inconvenience that second processing in which a processing load of the processing apparatus 10 is large is unnecessarily performed.

### Second Example Embodiment

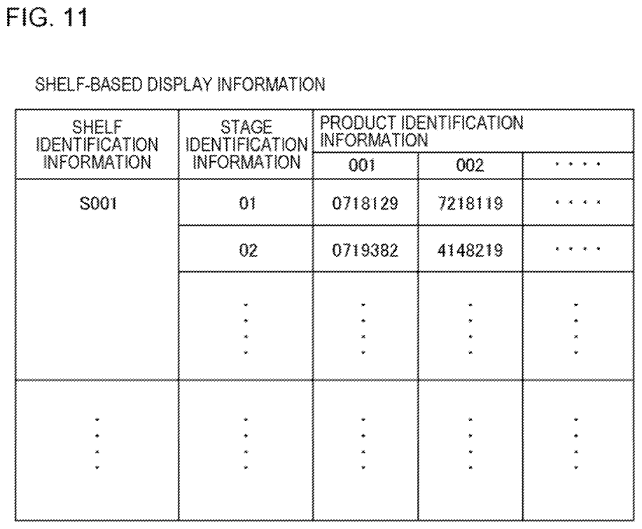

As illustrated in FIG. 11, shelf-based display information according to a present example embodiment indicates a product displayed on each stage of each of a plurality of product shelves. The shelf-based display information illustrated in FIG. 11 is information in which shelf identification information for mutually identifying a plurality of product shelves, stage identification information for mutually identifying a plurality of stages provided for each product shelf, and product identification information of a product displayed on each stage of each product shelf are associated with one another.

After determining that a first product pickup image is an image indicating a scene of picking up a product from a first product shelf, a determination unit 12 determines from which stage of the first product shelf the product is picked up by analyzing the first product pickup image. An algorithm for achieving the determination is not specifically limited. For example, as illustrated in the images 7 and 8 in FIG. 5, in a case where the first product shelf is included in the first product pickup image, it is possible determine from which stage each product is picked up by registering in advance a region occupied by each stage within an image, and based on a relationship between a region of each stage within the image, and a position of a picked up product.

Note that, in the following, it is assumed that “the first product pickup image” is an image indicating a scene of picking up a product from a “first stage” of “the first product shelf”.

After determining that the first product pickup image is an image indicating a scene of picking up a product from the first stage of the first product shelf, the determination unit 12 determines a product group displayed on the first stage of the first product shelf, based on “shelf-based display information (see FIG. 11) indicating a product displayed on each stage of each of a plurality of product shelves”.

Further, a first recognition unit 13 recognizes a product included in the first product pickup image by recognition processing in which a part of pieces of product feature value information indicating a feature value of an external appearance of a plurality of products is set as a collation target. The part as a collation target is a feature value of a product group determined, by the determination unit 12, as a product displayed on the first stage of the first product shelf.

Note that, as described in the first example embodiment, in the first recognition unit 13, recognition processing may be constituted of a plurality of steps.

For example, the first recognition unit 13 may have a two-step configuration constituted of first recognition processing in which a feature value of a product group determined as a product displayed on the first stage of the first product shelf is set as a collation target, and second recognition processing in which feature values of all products are set as a collation target, and in a case where product recognition cannot be accurately performed by the first recognition processing, the second recognition processing may be performed.

In addition to the above, the first recognition unit 13 may have a three-step configuration constituted of first recognition processing in which a feature value of a product group determined as a product displayed on the first stage of the first product shelf is set as a collation target, second recognition processing in which a feature value of a product group determined as a product displayed on the first product shelf is set as a collation target, and third recognition processing in which feature values of all products are set as a collation target, and in a case where product recognition cannot be accurately performed by the first recognition processing, the second recognition processing may be performed, and in a case where product recognition cannot be accurately performed by the second recognition processing, the third recognition processing may be performed.

Other configurations of a processing apparatus 10 are similar to those of the first example embodiment.

In the processing apparatus 10 according to the present example embodiment, an advantageous effect similar to that of the first example embodiment is achieved. Further, in the processing apparatus 10 according to the present example embodiment, since a collation target for recognition processing can be further narrowed down, a processing load of the processing apparatus 10 is further reduced.

### Third Example Embodiment

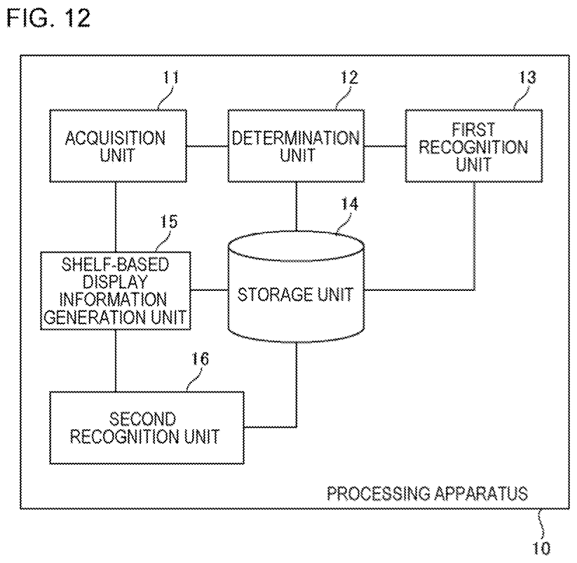

A processing apparatus 10 according to a present example embodiment includes a function of automatically generating shelf-based display information. FIG. 12 illustrates one example of a functional block diagram of the processing apparatus 10 according to the present example embodiment. As illustrated in FIG. 12, the processing apparatus 10 includes an acquisition unit 11, a determination unit 12, a first recognition unit 13, a storage unit 14, a second recognition unit 15, and a shelf-based display information generation unit 16.

The acquisition unit 11 acquires a plurality of product replenishment images indicating a scene of replenishing with a product on each of a plurality of product shelves by a salesperson. A configuration of a camera for generating a product replenishment image is similar to a configuration of a camera for generating a product pickup image described in the first example embodiment. For example, a scene of replenishing with a product on a product shelf 1 by a salesperson can be photographed by a camera 2 as illustrated in FIGS. 3 to 5. The camera for generating a product replenishment image may be the same camera as a camera for generating a product pickup image, or may be a camera different from the above.

A product replenishment image generated by a camera may be input to the processing apparatus 10 by real-time processing, or may be input to the processing apparatus 10 by batch processing. However, in order to eliminate a discrepancy between shelf-based display information and an actual display status, it is preferable to input a product replenishment image to the processing apparatus 10 by real-time processing, and update shelf-based display information with a less time loss from replenishment.

The second recognition unit 15 recognizes a product included in a product replenishment image by recognition processing in which a feature value of an external appearance of all products indicated by product feature value information is set as a collation target. The second recognition unit 15 is different from the first recognition unit 13 in a point that, whereas the first recognition unit 13 for recognizing a product picked up from a product shelf by a customer sets, as a collation target, a feature value of a part of products among pieces of product feature value information, the second recognition unit 15 for recognizing a product to be replenished on a product shelf by a salesperson sets, as a collation target, a feature value of an external appearance of all products indicated by product feature value information.

The shelf-based display information generation unit 16 determines on which one of a plurality of product shelves, a product is replenished regarding a first product replenishment image being one of a plurality of product replenishment images acquired by the acquisition unit 11, which represents an image indicating a scene of replenishing with a product.

For example, in a case where installation positions of a plurality of cameras for photographing a plurality of product shelves are fixed, the shelf-based display information generation unit 16 may determine on which product shelf, a product is replenished regarding the first product replenishment image, which represents an image indicating a scene of replenishing with a product, by determining a camera that has generated the first product replenishment image. In addition to the above, in a case where information indicating a photographing position is attached to a product replenishment image, the shelf-based display information generation unit 16 may determine on which product shelf, a product is replenished regarding the first product replenishment image, which represents an image indicating a scene of replenishing with a product, by collating between information indicating the photographing position, and information indicating an installation position of each of a plurality of product shelves prepared in advance. In addition to the above, in a case where information (such as a shelf number) for mutual identification is physically attached to each of product shelves, and a product replenishment image includes the information, the shelf-based display information generation unit 16 may determine on which product shelf, a product is replenished regarding the first product replenishment image, which represents an image indicating a scene of replenishing with a product, by analyzing the product replenishment image, and recognizing the information attached to the product shelf.

Note that, hereinafter, it is assumed that “the first product replenishment image” is an image indicating a scene of replenishing with a product on a “first product shelf” among a plurality of product shelves.

After determining that the first product replenishment image is an image indicating a scene of replenishing with a product on the first product shelf, the shelf-based display information generation unit 16 registers, in shelf-based display information (see FIG. 7), a product recognized to be included in the first product replenishment image by the second recognition unit 15, as a product displayed on the first product shelf.

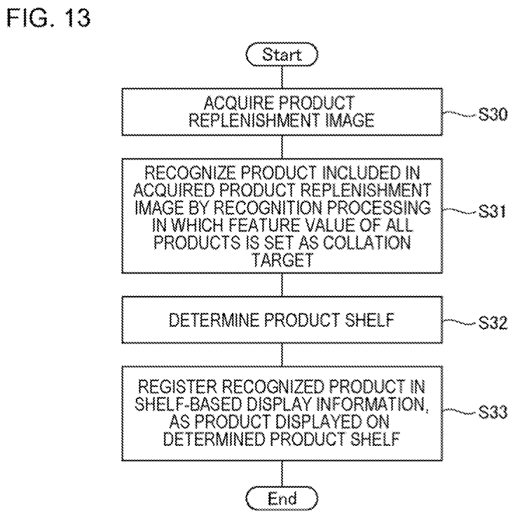

Next, one example of a flow of processing of the processing apparatus 10 is described by using a flowchart in FIG. 13.

First, in response to acquisition of a product replenishment image as a processing target by the acquisition unit 11 (S30), the second recognition unit 15 recognizes a product included in the product replenishment image acquired in S30 by recognition processing in which a feature value of an external appearance of all products indicated by product feature value information is set as a collation target (S31).

Subsequently, the shelf-based display information generation unit 16 determines on which one of a plurality of product shelves, a product is replenished regarding the product replenishment image acquired in S30, which represents an image indicating a scene of replenishing with a product (S32). Subsequently, the shelf-based display information generation unit 16 registers, in shelf-based display information, a product recognized to be included in the product replenishment image acquired in S30, as a product displayed on the product shelf determined in S32 (S33). Note that, registration processing may not be performed in a case where a product has already been registered, and registration processing may be performed only in a case where a product is not registered.

Herein, a modification example of the present example embodiment is described. After determining that the first product replenishment image indicates a scene of replenishing with a product on the first product shelf, the shelf-based display information generation unit 16 may determine on which stage of the first product shelf, the product is replenished by analyzing the first product replenishment image. An algorithm for achieving the determination is not specifically limited. For example, as illustrated in the images 7 and 8 in FIG. 5, in a case where the first product shelf is included in the first product replenishment image, it is possible to determine on which stage, each product is replenished by registering in advance a region occupied by each stage within an image, and based on a relationship between a region of each stage within the image, and a replenishment position of a product.

After determining on which stage of the first product shelf, a product is replenished regarding the first product replenishment image, which represents a scene of replenishing with a product, the shelf-based display information generation unit 16 registers, in shelf-based display information (see FIG. 11), a product recognized to be included in the first product replenishment image by the second recognition unit 15, as a product displayed on the determined stage of the first product shelf.

Other configurations of the processing apparatus 10 are similar to those of the first and second example embodiments.

In the processing apparatus 10 according to the present example embodiment, an advantageous effect similar to that of the first and second example embodiments is achieved. Further, according to the processing apparatus 10, shelf-based display information can be automatically generated without manpower. Therefore, a work load of a salesperson can be reduced.

Further, according to the processing apparatus 10, a product replenished on each product shelf is determined by analyzing a product replenishment image indicating a scene of replenishing with a product on a product shelf by a salesperson, and shelf-based display information is generated based on a result of the determination. According to the processing apparatus 10 as described above, it is possible to generate shelf-based display information of less error.

Further, according to the processing apparatus 10, it is possible to recognize a product replenished on a product shelf by a salesperson by recognition processing in which a feature value of an external appearance of all products indicated by product feature value information is set as a collation target. Therefore, even when a product displayed on each product shelf is changed, it is possible to accurately recognize the product, and register correct information in shelf-based display information.

### Fourth Example Embodiment

A processing apparatus 10 according to a present example embodiment generates shelf-based display information by a method described in the third example embodiment. Further, a same camera photographs “a scene of picking up a product from a product shelf by a customer”, and “a scene of replenishing with a product on a product shelf by a salesperson”, and generates a product pickup image and a product replenishment image. This configuration reduces the number of cameras to be installed, and reduces a cost required for a facility.

As described in the first to third example embodiments, a processing content to be performed by the processing apparatus 10 is different according to determination as to whether an image generated by a camera is a product pickup image or a product replenishment image. In view of the above, the processing apparatus 10 includes a function of classifying an image generated by a camera into a product pickup image and a product replenishment image.

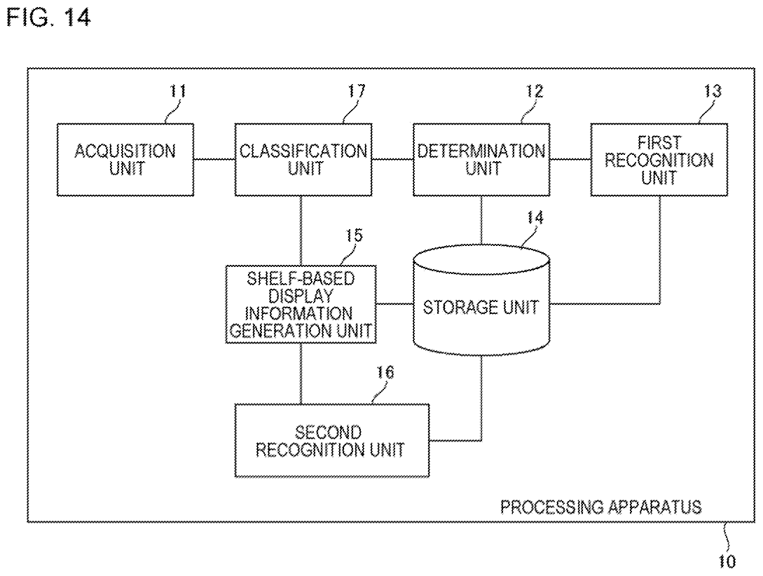

FIG. 14 illustrates one example of a functional block diagram of the processing apparatus 10 according to the present example embodiment. As illustrated in FIG. 14, the processing apparatus 10 includes an acquisition unit 11, a determination unit 12, a first recognition unit 13, a storage unit 14, a second recognition unit 15, a shelf-based display information generation unit 16, and a classification unit 17.

The classification unit 17 classifies an image generated by a camera into a product pickup image and a product replenishment image. For example, the classification unit 17 performs the classification, based on a photographing time of an image, a feature value of an external appearance of a person included in an image, or a mode set at a photographing time of an image. In the following, examples of classification processing are described.

### Classification Processing Example 1

In the example, a time period during which a product is replenished on a product shelf is determined in advance. For example, a time period or the like before a store is opened becomes a time period during which a product is replenished on a product shelf. Further, the classification unit 17 classifies an image in which a photographing time is included in a time period during which a product is replenished on a product shelf, as a product replenishment image, and classifies an image other than the above, as a product pickup image.

### Classification Processing Example 2

In the example, a salesperson wearing a predetermined uniform replenishes with a product. The classification unit 17 determines whether “a person holding a product in a hand”, which is included in an image, is a salesperson, based on whether the person included in the image is wearing the uniform. Further, the classification unit 17 classifies the image including the salesperson holding the product in the hand, as a product replenishment image, and classifies an image other than the above, as a product pickup image.

### Classification Processing Example 3

In the example, a feature value of an external appearance of a face of a salesperson is registered in advance in a database. The classification unit 17 determines whether “a person holding a product in a hand”, which is included in an image, is a salesperson, by collating between a feature value of an external appearance of a face of the person included in the image, and a feature value in the database. Further, the classification unit 17 classifies the image including the salesperson holding the product in the hand, as a product replenishment image, and classifies an image other than the above, as a product pickup image.

### Classification Processing Example 4

In the example, a normal photographing mode and a product replenishment photographing mode are present in a camera. Switching of the mode is achieved by an input by a salesperson. The input may be performed via an input apparatus (such as a physical button, a microphone, a touch panel, a keyboard, and a mouse) installed near a product shelf, in a backyard of a store, or the like, may be performed by a gesture input that allows a camera installed near a product shelf to photograph a predetermined gesture, or may be performed by an input via a portable apparatus such as a smartphone, a tablet terminal, a smartwatch, and a mobile phone. A camera for photographing a predetermined gesture may be the same camera as a camera for photographing “a scene of picking up a product from a product shelf by a customer”, and “a scene of replenishing with a product on a product shelf by a salesperson”.

Further, the classification unit 17 classifies an image generated at the product replenishment photographing mode, as a product replenishment image, and classifies an image generated at the normal photographing mode, as a product pickup image.

For example, information indicating at which mode, an image is generated may be attached to an image generated by a camera. Further, the classification unit 17 may determine at which mode, each image is generated, based on the information.

In addition to the above, a camera may hold history information on a mode. The history information indicates a time period of each mode. Further, the classification unit 17 may determine at which mode, each image is generated, based on the history information, and a photographing time of each image.

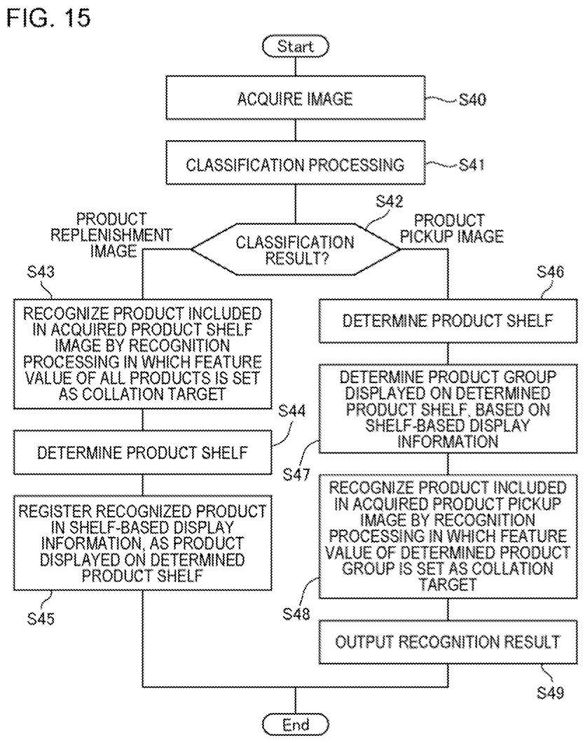

Next, one example of a flow of processing of the processing apparatus 10 is described by using a flowchart in FIG. 15.

First, in response to acquisition of an image as a processing target by the acquisition unit 11 (S40), the classification unit 17 performs classification processing, and classifies the image into a product pickup image or a product replenishment image (S41).

In a case where the image is classified as the product replenishment image (“product replenishment image” in S42), the processing apparatus 10 performs pieces of processing from S43 to S45. The pieces of processing from S43 to S45 are the same as pieces of processing from S31 to S33 in FIG. 13.

On the other hand, in a case where the image is classified as the product pickup image (“product pickup image” in S42), the processing apparatus 10 performs pieces of processing from S46 to S49. The pieces of processing from S46 to S49 are the same as pieces of processing from S11 to S14 in FIG. 9.

Other configurations of the processing apparatus 10 are similar to those of the first to third example embodiments.

In the processing apparatus 10 according to the present example embodiment, an advantageous effect similar to that of the first to third example embodiments is achieved. Further, according to the processing apparatus 10, a same camera can photograph “a scene of picking up a product from a product shelf by a customer”, and “a scene of replenishing with a product on a product shelf by a salesperson”, and generate a product pickup image and a product replenishment image. This configuration reduces the number of cameras to be installed, and reduces a cost required for a facility.

Further, according to the processing apparatus 10, it is possible to automatically classify an image generated by a camera into a product pickup image and a product replenishment image. Since manpower is not needed, a work load of a salesperson can be reduced.

### Fifth Example Embodiment

A processing apparatus 10 according to a present example embodiment includes a function of automatically generating shelf-based display information by a method different from that of the third and fourth example embodiments. FIG. 12 illustrates one example of a functional block diagram of the processing apparatus 10 according to the present example embodiment. As illustrated in FIG. 12, the processing apparatus 10 includes an acquisition unit 11, a determination unit 12, a first recognition unit 13, a storage unit 14, a second recognition unit 15, and a shelf-based display information generation unit 16.

The acquisition unit 11 acquires a plurality of product shelf images generated by photographing each of a plurality of product shelves. The product shelf image includes a product displayed on a product shelf. A configuration of a camera for generating a product shelf image is similar to a configuration of a camera for generating a product pickup image described in the first example embodiment. For example, by adjusting a photographing direction of a camera 2 as illustrated in FIGS. 3 to 5, it is possible to photograph in such a way as to include a product displayed on a product shelf.

A camera for generating a product shelf image may be a same camera as a camera for generating a product pickup image, or may be a camera different from the above. In a case where a same camera is used, for example, by adjusting a photographing direction of the camera 2 as illustrated in FIGS. 3 to 5, it is possible to photograph in such a way as to include both of “a scene of picking up a product from a product shelf by a customer”, and “the product displayed on the product shelf”.

A product shelf image generated by a camera may be input to the processing apparatus 10 by real-time processing, or may be input to the processing apparatus 10 by batch processing. However, in order to eliminate a discrepancy between shelf-based display information and an actual display status, it is preferable to input a product shelf image to the processing apparatus 10 by real-time processing, and update shelf-based display information with a less time loss from product shelf image photographing.

The second recognition unit 15 recognizes a product included in a product shelf image by recognition processing in which a feature value of an external appearance of all products indicated by product feature value information is set as a collation target. The second recognition unit 15 is different from the first recognition unit 13 in a point that, whereas the first recognition unit 13 for recognizing a product picked up from a product shelf by a customer sets, as a collation target, a feature value of a part of products among pieces of product feature value information, the second recognition unit 15 for recognizing a product displayed on a product shelf sets, as a collation target, a feature value of an external appearance of all products indicated by product feature value information.

The shelf-based display information generation unit 16 determines which one of a plurality of product shelves, an image includes regarding a first product shelf image being one of a plurality of product shelf images acquired by the acquisition unit 11.

For example, in a case where installation positions of a plurality of cameras for photographing a plurality of product shelves are fixed, the shelf-based display information generation unit 16 may determine which product shelf, an image includes regarding the first product shelf image, by determining a camera that has generated the first product shelf image. In addition to the above, in a case where information indicating a photographing position is attached to a product shelf image, the shelf-based display information generation unit 16 may determine which product shelf, an image includes regarding the first product shelf image, by collating between information indicating the photographing position, and information indicating an installation position of each of a plurality of product shelves prepared in advance. In addition to the above, in a case where information (such as a shelf number) for mutual identification is physically attached to each of product shelves, and a product shelf image includes the information, the shelf-based display information generation unit 16 may determine which product shelf, an image includes regarding the first product shelf image, by analyzing the product shelf image, and recognizing the information attached to the product shelf.

Note that, hereinafter, it is assumed that “the first product shelf image” is an image including “the first product shelf” among a plurality of product shelves.

After determining that the first product shelf image is an image including the first product shelf, the shelf-based display information generation unit 16 registers, in shelf-based display information (see FIG. 7), a product recognized to be included in the first product shelf image by the second recognition unit 15, as a product displayed on the first product shelf.

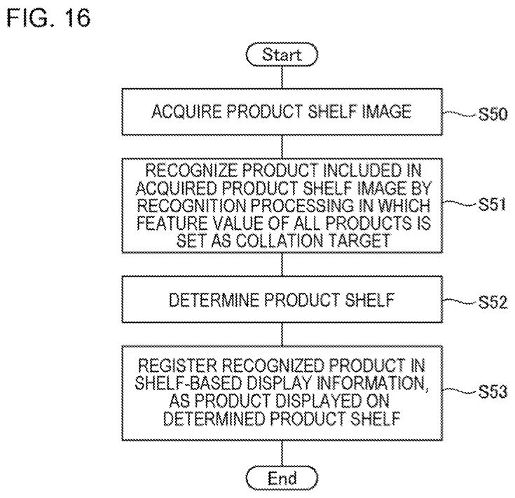

Next, one example of a flow of processing of the processing apparatus 10 is described by using a flowchart in FIG. 16.

First, in response to acquisition of a product shelf image as a processing target by the acquisition unit 11 (S50), the second recognition unit 15 recognizes a product included in the product shelf image acquired in S50 by recognition processing in which a feature value of an external appearance of all products indicated by product feature value information is set as a collation target (S51).

Subsequently, the shelf-based display information generation unit 16 determines which one of a plurality of product shelves, an image includes regarding the product shelf image acquired in S50 (S52). Subsequently, the shelf-based display information generation unit 16 registers, in shelf-based display information, a product recognized to be included in the product shelf image acquired in S50, as a product displayed on the product shelf determined in S52 (S53). Note that, registration processing may not be performed in a case where a product has already been registered, and registration processing may be performed only in a case where a product is not registered.

Herein, a modification example of the present example embodiment is described. After determining that the first product shelf image is an image including the first product shelf, the shelf-based display information generation unit 16 may determine on which stage of the first product shelf, a product recognized to be included in the first product shelf image is displayed by analyzing the first product shelf image. An algorithm for achieving the determination is not specifically limited. For example, in a case where a plurality of stages are included in the first product shelf image, it is possible to determine on which stage, each product is displayed by registering in advance a region occupied by each stage within an image, and based on a relationship between a region of each stage within the image, and a position of a recognized product within the image. Further, in a case where a product shelf image is generated for each stage by photographing for each stage, for example, it is possible to determine which stage of each product shelf, an image includes regarding each product shelf image by processing similar to the above-described “processing of determining which one of a plurality of product shelves, an image includes regarding the first product shelf image”.

After determining which stage of the first product shelf, the first product shelf image includes, the shelf-based display information generation unit 16 registers, in shelf-based display information (see FIG. 11), a product recognized to be included in the first product replenishment image by the second recognition unit 15, as a product displayed on the determined stage of the first product shelf.

Other configurations of the processing apparatus 10 are similar to those of the first and second example embodiments.

In the processing apparatus 10 according to the present example embodiment, an advantageous effect similar to that of the first and second example embodiments is achieved. Further, according to the processing apparatus 10, shelf-based display information can be automatically generated without manpower. Therefore, a work load of a salesperson can be reduced.

Further, according to the processing apparatus 10, a product displayed on each product shelf is determined by analyzing a product shelf image including a product displayed on a product shelf, and shelf-based display information is generated based on a result of the determination. According to the processing apparatus 10 as described above, it is possible to generate shelf-based display information of less error.

Further, according to the processing apparatus 10, it is possible to recognize a product displayed on a product shelf by recognition processing in which a feature value of an external appearance of all products indicated by product feature value information is set as a collation target. Therefore, even when a product displayed on each product shelf is changed, it is possible to accurately recognize the product, and register correct information in shelf-based display information.

### Sixth Example Embodiment

A processing apparatus 10 according to a present example embodiment generates shelf-based display information by a method described in the fifth example embodiment. Further, a same camera photographs in such a way as to include “a scene of picking up a product from a product shelf by a customer”, and “the product displayed on the product shelf”. Specifically, an image generated by the camera indicates both of “a scene of picking up a product from a product shelf by a customer”, and “the product displayed on the product shelf”. This configuration reduces the number of cameras to be installed, and reduces a cost required for a facility.

When processing by the second recognition unit 15 and the shelf-based display information generation unit 16 described in the fifth example embodiment is performed for all images generated by a camera, a processing load of the processing apparatus 10 increases.

In view of the above, in a case where a predetermined display content confirmation condition is satisfied, the processing apparatus 10 according to the present example embodiment performs processing by a second recognition unit 15 and a shelf-based display information generation unit 16 for an image generated by a camera at a timing that satisfies the condition, and does not perform processing by the second recognition unit 15 and the shelf-based display information generation unit 16 for an image generated by the camera at a timing other than the above.

Examples of the display content confirmation condition include, for example, “a time has reached a predetermined time”, “receiving an input of a display content confirmation instruction from a salesperson”, and the like. For example, after displaying a product on a display shelf, a salesperson inputs a display content confirmation instruction.

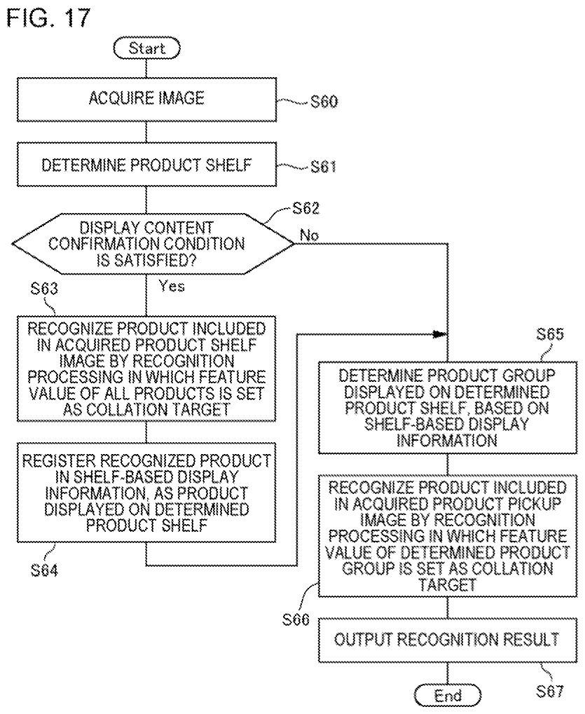

Next, one example of a flow of processing of the processing apparatus 10 is described by using a flowchart in FIG. 17.

First, in response to acquisition of an image as a processing target by an acquisition unit 11 (S60), the processing apparatus 10 determines which one of a plurality of product shelves, an image regarding the image acquired in S60 includes (S61).

Subsequently, in a case where the display content confirmation condition is satisfied (Yes in S62), the processing apparatus 10 performs pieces of processing of S63 and S64. The pieces of processing of S63 and S64 are the same as pieces of processing of S51 and S53 in FIG. 16. Thereafter, the processing apparatus 10 performs pieces of processing from S65 to S67. The pieces of processing from S65 to S67 are the same as pieces of processing from S12 to S14 in FIG. 9.

On the other hand, in a case where the display content confirmation condition is not satisfied (No in S62), the processing apparatus 10 performs the pieces of processing from S65 to S67 without performing the pieces of processing of S63 and S64.

Other configurations of the processing apparatus 10 are similar to those of the first, second, and fifth example embodiments.

In the processing apparatus 10 according to the present example embodiment, an advantageous effect similar to that of the first, second, and fifth example embodiments is achieved. Further, according to the processing apparatus 10, it is possible to photograph, by a same camera, in such a way as to include “a scene of picking up a product from a product shelf by a customer”, and “the product displayed on the product shelf”. This configuration reduces the number of cameras to be installed, and reduces a cost required for a facility.

Further, according to the processing apparatus 10, in a case where a predetermined condition of confirming a display content of a product shelf is satisfied, it is possible to perform processing by the second recognition unit 15 and the shelf-based display information generation unit 16, and perform processing of generating shelf-based display information. In this case, it is possible to suppress an inconvenience that processing by the second recognition unit 15 and the shelf-based display information generation unit 16 in which a processing load of a computer is large is unnecessarily and frequently performed. Consequently, a processing load of the processing apparatus 10 is reduced.

### Seventh Example Embodiment

A shelf-based display information generation unit 16 of a processing apparatus 10 according to a present example embodiment deletes, from a product displayed on a product shelf indicated by shelf-based display information (see FIGS. 7 and 11), a product causing a state that no product is displayed on the product shelf because of being picked up from the product shelf.

For example, the shelf-based display information generation unit 16 counts the number of products picked up from each product shelf for each product, based on a recognition result of a first recognition unit 13, and deletes, from a product displayed on each product shelf indicated by shelf-based display information, a product in which the number has reached a reference value.

As another example, the shelf-based display information generation unit 16 can delete, from a product displayed on each product shelf indicated by shelf-based display information, a product in which the number of sales indicated by sales information being managed by a point of sales (POS) system has reached a reference value.

The reference value is the number of products displayed on a product shelf. A salesperson may input and register the reference value in the processing apparatus 10 for each product. In addition to the above, the processing apparatus 10 may determine and set, as the reference value, the number of products displayed on a product shelf, based on a recognition result of the second recognition unit 15 described in the third to sixth example embodiments.

Other configurations of the processing apparatus 10 are similar to those of the first to sixth example embodiments.

In the processing apparatus 10 according to the present example embodiment, an advantageous effect similar to that of the first to sixth example embodiments is achieved. Further, according to the processing apparatus 10, it is possible to eliminate, from a collation target, a feature value of a product which has run out on a product shelf. Consequently, a processing load of the processing apparatus 10 can be further reduced.

Further, the processing apparatus 10 can determine a product which has run out on a product shelf without manpower, and automatically update shelf-based display information. Therefore, a work load of a salesperson can be reduced.

Further, the processing apparatus 10 can determine a product which has run out on a product shelf, based on a recognition result of the first recognition unit 13 for recognizing a product picked up from a product shelf by a customer, or sales information and the like being managed by a POS system. Therefore, it is possible to accurately determine a product which has run out on a product shelf.

Note that, in the present description, “acquisition” includes at least one of “acquisition of data stored in another apparatus or a storage medium by an own apparatus (active acquisition)”, based on a user input, or based on a command of a program, for example, requesting or inquiring another apparatus and receiving, accessing to another apparatus or a storage medium and reading, and the like, “input of data to be output from another apparatus to an own apparatus (passive acquisition)”, based on a user input, or based on a command of a program, for example, receiving data to be distributed (or transmitted, push-notified, or the like), and acquiring by selecting from received data or information, and “generating new data by editing data (such as converting into a text, rearranging data, extracting a part of pieces of data, and changing a file format) and the like, and acquiring the new data”.

While the invention of the present application has been described with reference to the example embodiments (and examples), the invention of the present application is not limited to the above-described example embodiments (and examples). A configuration and details of the invention of the present application can be modified in various ways comprehensible to a person skilled in the art within the scope of the invention of the present application.

A part or all of the above-described example embodiments may also be described as the following supplementary notes, but is not limited to the following.

1. A processing apparatus including:

an acquisition unit that acquires a product pickup image indicating a scene of picking up a product from a first product shelf by a customer;

a determination unit that determines a product group displayed on the first product shelf, based on shelf-based display information indicating a product displayed on each product shelf; and

a first recognition unit that recognizes a product included in the product pickup image by recognition processing in which the determined product group is set as a collation target among pieces of product feature value information indicating a feature value of an external appearance of a plurality of products.

2. The processing apparatus according to supplementary note 1, wherein

the acquisition unit further acquires a product replenishment image indicating a scene of replenishing with a product on the first product shelf by a salesperson,

the processing apparatus further including:

a second recognition unit that recognizes a product included in the product replenishment image by recognition processing in which all products indicated by the product feature value information are set as a collation target; and

a shelf-based display information generation unit that registers, in the shelf-based display information, a product recognized to be included in the product replenishment image, as a product displayed on the first product shelf.

3. The processing apparatus according to supplementary note 1 or 2, wherein

a same camera generates the product pickup image and the product replenishment image,

the processing apparatus further including

a classification unit that classifies an image generated by the camera into the product pickup image and the product replenishment image.

4. The processing apparatus according to supplementary note 3, wherein

the classification unit performs the classification, based on a photographing time of the image, a feature value of an external appearance of a person included in the image, or a mode set at a photographing time of the image.

5. The processing apparatus according to supplementary note 1, wherein

the acquisition unit further acquires a product shelf image including a product displayed on the first product shelf,

the processing apparatus further including:

a second recognition unit that recognizes a product included in the product shelf image by recognition processing in which all products indicated by the product feature value information are set as a collation target; and

a shelf-based display information generation unit that registers, in the shelf-based display information, a product recognized to be included in the product shelf image, as a product displayed on the first product shelf.

6. The processing apparatus according to any one of supplementary notes 1 to 5, wherein

the determination unit
determines, based on the product pickup image, a stage on which a product picked up from the first product shelf is displayed, and
determines, based on the shelf-based display information indicating a product displayed on each stage of each of the plurality of product shelves, a product group displayed on a the determined stage of the first product shelf, and

the first recognition unit recognizes a product included in the product pickup image by recognition processing in which the product group determined to be displayed on the determined stage is set as a collation target among pieces of the product feature value information.

7. The processing apparatus according to any one of supplementary notes 1 to 6, wherein

the shelf-based display information generation unit counts, based on a recognition result of the first recognition unit, a number of products picked up from the first product shelf for each product, and deletes, from a product displayed on the first product shelf indicated by the shelf-based display information, a product in which the number has reached a reference value.

8. The processing apparatus according to any one of supplementary notes 1 to 6, wherein

the shelf-based display information generation unit deletes, from a product displayed on the first product shelf indicated by the shelf-based display information, a product in which a number of sales indicated by sales information being managed by a POS system has reached a reference value.

9. A processing method including,

by a computer:

acquiring a product pickup image indicating a scene of picking up a product from a first product shelf by a customer;

determining a product group displayed on the first product shelf, based on shelf-based display information indicating a product displayed on each product shelf; and

recognizing a product included in the product pickup image by recognition processing in which the determined product group is set as a collation target among pieces of product feature value information indicating a feature value of an external appearance of a plurality of products.

10. A program causing a computer to function as:

an acquisition unit that acquires a product pickup image indicating a scene of picking up a product from a first product shelf by a customer;

a determination unit that determines a product group displayed on the first product shelf, based on shelf-based display information indicating a product displayed on each product shelf; and

a first recognition unit that recognizes a product included in the product pickup image by recognition processing in which the determined product group is set as a collation target among pieces of product feature value information indicating a feature value of an external appearance of a plurality of products.

What is claimed is:

1. A processing apparatus comprising:
at least one memory configured to store one or more instructions; and
at least one processor configured to execute the one or more instructions to:
acquire a product pickup image indicating a scene of picking up a product from a first product shelf by a customer;
determine a product group displayed on the first product shelf, based on shelf-based display information indicating a product displayed on each product shelf; and
recognize a product included in the product pickup image by recognition processing in which the determined product group is set as a collation target among pieces of product feature value information indicating a feature value of an external appearance of a plurality of products.

2. The processing apparatus according to claim 1, wherein the processor is further configured to execute the one or more instructions to:
acquire a product replenishment image indicating a scene of replenishing with a product on the first product shelf by a salesperson,
recognize a product included in the product replenishment image by recognition processing in which all products indicated by the product feature value information are set as a collation target; and
register, in the shelf-based display information, a product recognized to be included in the product replenishment image, as a product displayed on the first product shelf.

3. The processing apparatus according to claim 1, wherein
a same camera generates the product pickup image and the product replenishment image,
the processor is further configured to execute the one or more instructions to classify an image generated by the camera into the product pickup image and the product replenishment image.

4. The processing apparatus according to claim 3, wherein
the processor is further configured to execute the one or more instructions to perform the classification, based on a photographing time of the image, a feature value of an external appearance of a person included in the image, or a mode set at a photographing time of the image.

5. The processing apparatus according to claim 1, wherein the processor is further configured to execute the one or more instructions to:
acquire a product shelf image including a product displayed on the first product shelf,
recognize a product included in the product shelf image by recognition processing in which all products indicated by the product feature value information are set as a collation target; and
register, in the shelf-based display information, a product recognized to be included in the product shelf image, as a product displayed on the first product shelf.

6. The processing apparatus according to claim 1, wherein the processor is further configured to execute the one or more instructions to:
determine, based on the product pickup image, a stage on which a product picked up from the first product shelf is displayed, and
determine, based on the shelf-based display information indicating a product displayed on each stage of each of the plurality of product shelves, a product group displayed on a the determined stage of the first product shelf, and
recognize a product included in the product pickup image by recognition processing in which the product group determined to be displayed on the determined stage is set as a collation target among pieces of the product feature value information.

7. The processing apparatus according to claim 1, wherein
the processor is further configured to execute the one or more instructions to count, based on a recognition result of the recognizing a product included in the product pickup image, a number of products picked up from the first product shelf for each product, and delete, from a product displayed on the first product shelf indicated by the shelf-based display information, a product in which the number has reached a reference value.

8. The processing apparatus according to claim 1, wherein
the processor is further configured to execute the one or more instructions to delete, from a product displayed on the first product shelf indicated by the shelf-based display information, a product in which a number of sales indicated by sales information being managed by a point of sales (POS) system has reached a reference value.

9. A processing method comprising,
by a computer:
acquiring a product pickup image indicating a scene of picking up a product from a first product shelf by a customer;
determining a product group displayed on the first product shelf, based on shelf-based display information indicating a product displayed on each product shelf; and
recognizing a product included in the product pickup image by recognition processing in which the determined product group is set as a collation target among pieces of product feature value information indicating a feature value of an external appearance of a plurality of products.

10. A non-transitory storage medium storing a program causing a computer to:
acquire a product pickup image indicating a scene of picking up a product from a first product shelf by a customer;
determine a product group displayed on the first product shelf, based on shelf-based display information indicating a product displayed on each product shelf; and
recognize a product included in the product pickup image by recognition processing in which the determined product group is set as a collation target among pieces of product feature value information indicating a feature value of an external appearance of a plurality of products.
